(19) United States
(12) Patent Application Publication
(10) Pub. No.: US 2016/0221245 A1
(43) Pub. Date: Aug. 4, 2016

(54) METHOD FOR PRODUCING A FUEL TANK FROM PLASTIC MATERIAL

(71) Applicant: PLASTIC OMNIUM ADVANCED INNOVATION AND RESEARCH, Bruxelles (BE)

(72) Inventor: Eric BOUCAUX, Elincourt Sainte Marguerite (FR)

(73) Assignee: Plastic Omnium Advanced Innovation and Research, Bruxelles (BE)

(21) Appl. No.: 15/022,385

(22) PCT Filed: Sep. 23, 2014
(86) PCT No.: PCT/FR2014/052358

§ 371 Date: Mar. 16, 2016

(30) Foreign Application Priority Data
Sep. 26, 2013 (FR) FR1359309

(51) Int. Cl. B29C 49/18; B29C 49/56

(52) U.S. Cl. CPC B29C 49/18; B29C 49/56; B29L 2031/7172

(57) ABSTRACT

A method for producing a fuel tank from plastic material including: inserting a plastic parison into an open mold including mold cavities; introducing at least one obstacle element between the mold cavities; and introducing a pressurized fluid into the parison to perform pre-blowing of the parison and applying a part of the parison against the obstacle element to prevent the part of the parison from being clamped between the mold cavities.

The present invention concerns a method for producing a fuel tank from plastic material. The invention notably applies to the production of tanks for motor vehicles.

A number of techniques are known for producing a fuel tank from plastic material. One known production technique includes the following steps, in this order:
a) inserting a plastic material parison into an open mold comprising two mold cavities;
b) moving the mold cavities into contact to close the mold;
c) before complete closure of the mold, introducing a pressurized fluid (i.e. gas) into the interior of the parison in order to perform pre-blowing of the parison;
d) once the mold is completely closed, carrying out the final blowing of the parison to press it onto the mold cavities of the mold with the aid of the pressurized fluid;
e) opening the mold and extracting the tank.

A tank produced by this known technique generally has a projecting weld on its exterior perimeter (also called the joint plane of the tank). Such a weld results from the clamping (i.e. crushing) of the parison between the mold cavities of the mold. The presence of this projecting weld has a number of disadvantages.

A fuel tank is generally fixed to the chassis of a vehicle by means of one (or more) metal straps. The projecting weld impedes the passage of the strap in the sense that this projecting weld prevents the strap from espousing the exterior perimeter of the tank. The fixing of the tank to the chassis of the vehicle is therefore not optimized.

Another drawback resides in the fact that it is generally impossible or at least extremely difficult to fix a component to the exterior perimeter of the tank carrying the projecting weld. Now, it would be desirable to be able to use this surface, for example to attach cables or pipes to it.

Moreover, forming this projecting weld necessitates a surplus of material. This surplus of material increases not only the cost of producing the tank but also its weight.

The present invention aims to solve these problems.

To this end, in a particular embodiment of the invention, there is proposed a method for producing a fuel tank from plastic material, comprising the following steps, in this order:
a) inserting a plastic material parison into an open mold comprising mold cavities;
b) moving the mold cavities closer to (progressively) close the mold;
c) before complete closure of the mold, introducing a pressurized fluid into the interior of the parison in order to perform pre-blowing of the parison;
d) once the mold cavities are in contact (in the joint plane of the mold), carrying out the final blowing of the parison to press the parison onto the mold cavities of the mold with the aid of the pressurized fluid;
e) opening the mold and extracting the tank.
   The method comprises the following steps:
   before the pre-blowing of the parison, introducing at least one obstacle element between the mold cavities of the mold; and
   during the pre-blowing of the parison, pressing a portion of the parison onto the obstacle element with the aid of the pressurized fluid, so as to prevent said portion of the parison from being clamped between the mold cavities of the mold and to obtain a weld-free exterior perimeter area.

The tank produced by the method of the invention can therefore have on its exterior perimeter one (or more) area(s) (i.e. portions) with no projecting weld. At the time of the pre-blowing of the parison, that is to say when a pressurized fluid is introduced into the interior of the parison, a portion of the latter is therefore pressed onto an obstacle element. The obstacle element therefore prevents a portion of the parison from coming into contact with the mold cavities of the mold. To be more precise, the obstacle element in accordance with the invention makes it possible to hold a portion of the parison out of the joint plane of the mold (i.e. the junction plane between the mold cavities of the mold). For example, the obstacle element in accordance with the invention may be a longitudinal member or a plate. For example, in the particular case where the obstacle element is a longitudinal member, the tank produced by the method of the invention may have on its exterior perimeter one (or more) indentation(s) (i.e. area(s)) with no projecting weld.

The obstacle element is preferably introduced between the mold cavities of the mold before the pre-blowing and so that this obstacle element projects inside the mold. The obstacle element preferably remains in the same position during the pre-blowing and the final blowing of the parison.

In one particular embodiment, the obstacle element is able to pass from a folded position relative to the mold cavities of the mold to an unfolded position relative to the mold cavities of the mold, and vice versa.

When the mold is opened, the obstacle element is preferably in its folded position. When the mold is closed, the obstacle element is in its unfolded position and the mold cavities of the mold slide on the obstacle element until they are in contact. When the mold is closed, the obstacle element is again in its folded position.

The mold is opened once the pre-blowing and final blowing operations are finished.

In one particular embodiment, the obstacle element is in its folded position when the mold is opened.

In another embodiment, the obstacle element is in its unfolded position when the mold is opened. The obstacle element remains in its unfolded position to maintain the tank that has been produced in equilibrium. Once the tank that has been produced has been entirely removed from the mold, the obstacle element returns to its folded position. The advantage of such an embodiment is that it makes it possible to dispense with the use of a specific system for ejection from the mold; the obstacle element then replacing the ejectors conventionally used for removing the tank from the mold.

The obstacle element of the invention advantageously has the function of imparting a required shape to a parison portion during the pre-blowing and holding that parison portion out of the joint plane of the mold (i.e. the junction plane between the mold cavities of the mold) during the final blowing. Holding this parison portion out of the joint plane of the mold prevents it being clamped between the mold cavities and therefore forming a weld. A weld-free exterior perimeter area is therefore produced.

For example, in the particular case where the obstacle element is a longitudinal member, the tank produced in accordance with the method of the invention may have on its exterior perimeter one (or more) indentation(s) with no projecting weld. The indentation preferably extends toward the interior of the tank and is open toward the exterior of the tank.

By plastic material is meant any material including at least one synthetic resin polymer.

All types of plastic material may be suitable. Very suitable plastic materials belong to the category of thermoplastic materials.

By thermoplastic material is meant any thermoplastic polymer, including thermoplastic elastomers, and mixtures thereof. The term “polymer” designates both homopolymers and copolymers (notably binary or ternary copolymers). Non-limiting examples of such copolymers are: random distribution copolymers, sequenced copolymers, block copolymers and grafted copolymers.

Any type of thermoplastic copolymer or polymer the melting point of which is lower than the decomposition temperature is suitable. The synthetic thermoplastic materials that have a melting range extending over at least 10 degrees Celsius are very particularly suitable. Examples of such material are those that have a polydispersion of their molecular mass.

In particular, polyolefins, thermoplastic polyesters, polyketones, polyamides and their copolymers may be used. A mixture of polymers or copolymers may also be used, likewise a mixture of polymer materials with inorganic, organic and/or natural charges such as, for example, but non-limitingly: carbon, salts and other inorganic derivatives, natural or polymer fibers. It is also possible to use multilayer structures constituted of layers stacked and fastened together comprising at least one of the polymers or copolymers described above.

One polymer often employed is polyethylene. Excellent results have been obtained with high-density polyethylene (PEHD).

The tank for which the method in accordance with the invention is intended preferably comprises a multilayer structure comprising at least one layer of thermoplastic material and at least one supplementary layer which may advantageously be constituted of a liquid and/or gas barrier material.

The nature and the thickness of the barrier layer are preferably chosen to minimize the permeability to the liquids and the gases in contact with the wall of the tank. This layer is preferably based on a barrier material, i.e. a resin that is impermeable to the fuel, such as EVOH (partially hydrolyzed ethylene-vinyl acetate copolymer), for example. Alternatively, the tank may be subjected to a surface treatment (fluoration of sulfonation) with the object of rendering it impermeable to the fuel.

By “parison” is meant a one-piece preform, generally extruded and generally of substantially tubular shape, that is intended to constitute the wall of the tank after molding, that is to say after an operation that consists in imparting the required shapes and dimensions to the parison, which is in the molten state, with the aid of the mold, to produce a tank.

The method in accordance with the invention preferably uses an extruded parison. That parison may be obtained from an extruder with accumulation head, in which case the method generally uses a fixed mold opened at each cycle start to receive a parison. Alternatively, the method may have recourse to continuous extrusion either using a mobile mold that is closed periodically onto the latter or involving manipulation of the parison toward the mold.

The method in accordance with the invention uses a mold comprising mold cavities, that is to say kinds of hollow half-shells the perimeters of which are identical and the internal surface of which includes a raised pattern corresponding to the external shape of the tank, the tank being molded by pressing the parison onto this surface by means of a pressurized gas injected into the parison. In one particular embodiment, the pressurized gas may be injected with the aid of a blowing canula, for example. In one particular embodiment, the blowing canula may be inserted into the mold from below. In another embodiment, the blowing canula may be inserted through the side of the mold.

The method in accordance with the invention may use a tool for stretching the parison (holding it open). This tool may consist of clamps or jaws adapted to grip the edges of the parison and to hold them apart.

During the step c), the parison is preferably pre-blown (i.e. inflated) without contacting the mold cavities of the mold. Following the step c), the internal volume of the useful portion of the parison is generally equal to at least 60% of the internal volume of the tank, preferably at least 80% or even 90%.

The final blowing step d) serves primarily to impart to it its final raised pattern/shape.

During this pre-blowing step c), the mold is not closed and the lower and upper ends of the parison are preferably blocked in a sealed manner but without being closed (that is to say without having their edges welded but to the contrary held apart), by appropriate devices respectively situated below and above the mold. In one embodiment, these so-called sealing devices may consist in an internal block and two external mobile parts that come to clamp the parison onto the block. This kind of device gives good results for the lower device in particular. Where the upper device is concerned, the latter may be constituted by the extrusion head, that is to say that in this variant, which is moreover advantageous, the parison has not yet been cut off at the time of the pre-blowing but is still connected to the extrusion head. This variant makes it possible to dispense with the pre-blowing canula: in actual fact it suffices to provide the extrusion head with a blower device.

In the method in accordance with the invention, before the step e) of removal from the mold, the molded parison is preferably allowed to cool—generally by causing a cooling gas to circulate by means of one or more blower needles. The mold cavities of the mold are then preferably also cooled by circulating a fluid in a network of pipes.

In one particular embodiment of the invention, the mold cavities of the mold each comprise at least one mobile portion. Such mobile portions are configured to move closer to one another during the closing of the mold and to be assembled before the pre-blowing of the parison. Once assembled, these mobile portions form the obstacle element. By “assembling” is meant bringing the mobile portions into contact or coupling (i.e. connecting) the mobile portions to one another. Each mobile portion is preferably a sort of cylindrical beam the direction and the speed of movement of which are controllable. In one particular embodiment the mobile portions and the mold cavities of the mold may be moved with the aid of controllable hydraulic or pneumatic means.

The method in accordance with the invention advantageously comprises a step in which an accessory is mounted in the weld-free exterior perimeter area. The accessory is preferably mounted in resilient contact with the surface of the weld-free exterior perimeter area. In one particular embodiment, a fixing strap is mounted in resilient contact with the surface of the weld-free exterior perimeter area. The fixing strap can therefore have a shape complementary to that of the indentation. In another particular embodiment, a ventilation pipet (or any other type of component of a fuel system) may be welded in the weld-free exterior perimeter area. In another particular embodiment, one or more electrical cables may be attached (welded or clipped) in the weld-free exterior perimeter area.

In one particular embodiment of the invention, the obstacle element comprises raised patterns on its exterior surface. In this way, it is possible to form a weld-free exterior perimeter area including raised patterns. In one particular embodiment, the obstacle element may include raised patterns in the form of fins. The weld-free exterior perimeter area may therefore include fins configured, for example, to accelerate the thermal exchange between the weld-free exterior perimeter area and the external environment. In another particular embodiment, the obstacle element may include fish scale raised patterns. The weld-free exterior perimeter area can therefore include fish scale raised patterns. For example, these scales may be oriented oppositely to those that may be found on a fixing strap. This enables better attachment of the strap to the tank. In another particular embodiment, the obstacle element may include raised patterns forming a marking. The obstacle element of the invention may therefore be used to obtain easily a raised marking on the tank. In another particular embodiment, the weld-free exterior perimeter area may include raised patterns acting as stiffeners or local reinforcements.

In one particular embodiment of the invention, the obstacle element comprises thermal regulation means. For example, the obstacle element may incorporate a heating device adapted to maintain the temperature of the parison portion that is pressed onto the obstacle element at a given temperature value.

In one particular embodiment of the invention, the obstacle element comprises suction and/or blowing orifices. Such suction and/or blowing orifices may be used to produce a locally improved distribution of material during the operations of blowing the parison in the mold. This improved distribution of material is reflected in a reduction in the weight of the tank produced.

In one advantageous embodiment, the obstacle element (or the mobile portions that constitute it) is made of aluminum. In another embodiment, the obstacle element may be made of steel or of bronze.

The present invention also concerns a plastic material fuel tank produced by means of the method described above. The tank produced in this way may include on its exterior perimeter one (or more) area(s) (i.e. portions) with no projecting weld.

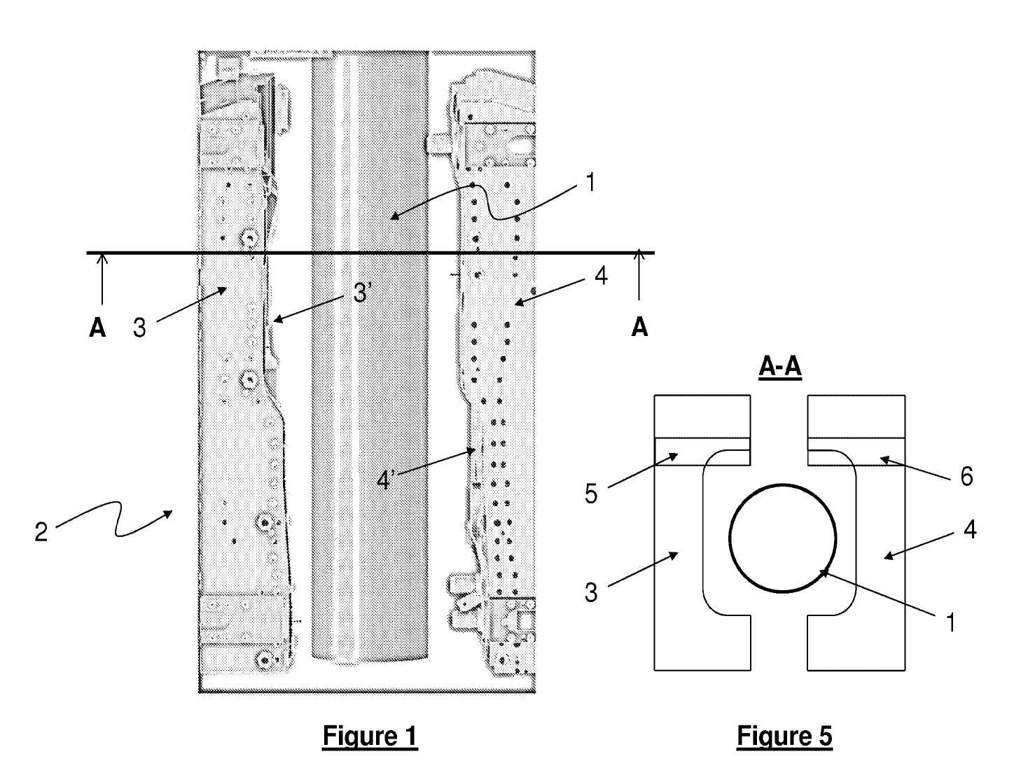

The purpose of FIGS. 1 to 8 is to show by way of nonlimiting illustrative example the principle of a method of manufacture in accordance with one particular embodiment of the invention.

In the examples of FIGS. 1 to 8 described below, the obstacle element in accordance with the invention is a longitudinal member of cylindrical shape. Of course, in other embodiments (not shown), the obstacle element in accordance with the invention may be a plate or a square beam.

As shown in the example from FIG. 1, a plastic material parison (1) is introduced between two mold cavities of a mold (2) in an open position. The parison (1) is introduced into the mold (2), whilst being held open/apart. The mold (2) comprises mold cavities (3, 4). The mold cavities (3, 4) of the mold have an internal surface (3′, 4′) corresponding to the external surface of the tank to be molded. FIG. 5 is a view in section taken along the line A-A in FIG. 1. In this embodiment, the mold cavities (3, 4) of the mold each comprise a mobile portion (5, 6) as shown in FIG. 5. As will be seen hereinafter, once assembled this pair of mobile portions (5, 6) form a longitudinal member (i.e. obstacle element). In another embodiment (not shown) the mold cavities (3, 4) of the mold may include a plurality of pairs of mobile portions disposed at different heights of the mold. In another embodiment (not shown), a longitudinal member (which in this case is a single block) may be mounted in the mold so that the mold cavities (3, 4) of the mold can slide on the longitudinal member during closing and opening of the mold. In another embodiment (not shown), the longitudinal member may be introduced into and retained in the mold by an external robot.

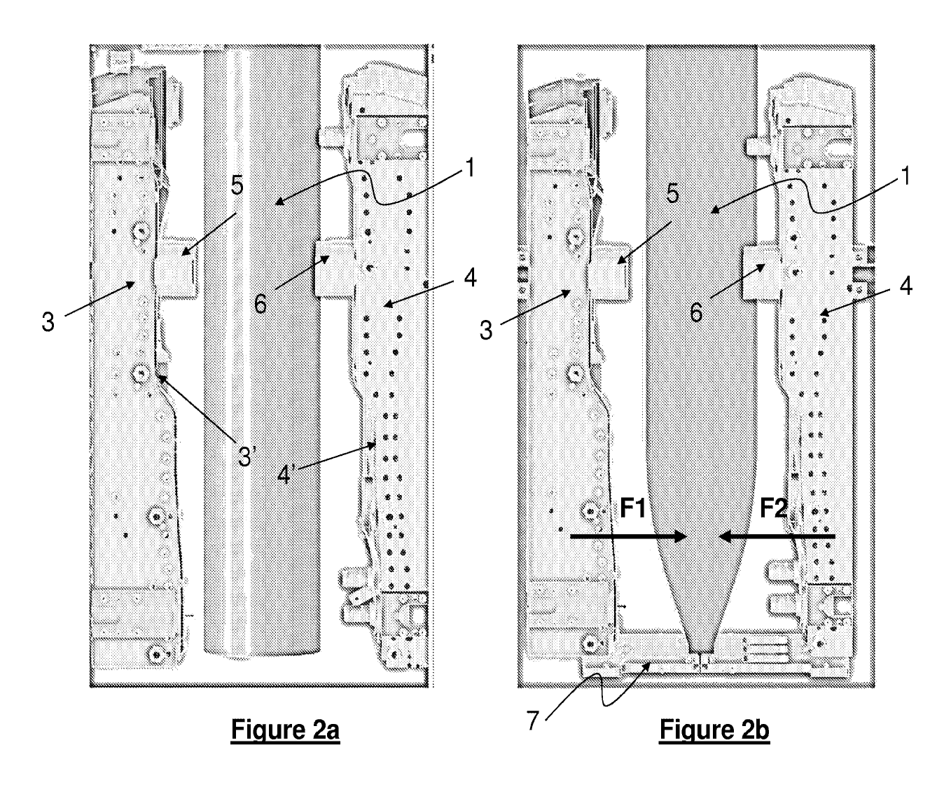

In FIG. 2a the mold (2) can be seen in a first intermediate closed position which is such that the mobile portions (5, 6) are introduced between the mold cavities (3, 4) of the mold. The mobile portions (5, 6) are in an unfolded position relative to the mold cavities of the mold and project inside the mold. In FIG. 2b the mold (2) can be seen in a second intermediate closed position which is such that the bottom of the parison is closed with the aid of a plate (7), also called a pre-blowing clamp. The mobile portions (5, 6) are moved toward one another in the direction of closing of the mold cavities (3, 4) of the mold, shown by the arrows (F1, F2). The mobile portions (5, 6) are moved toward one another until contact is made. This contact is produced before the pre-blowing of the parison, as shown in FIG. 6.

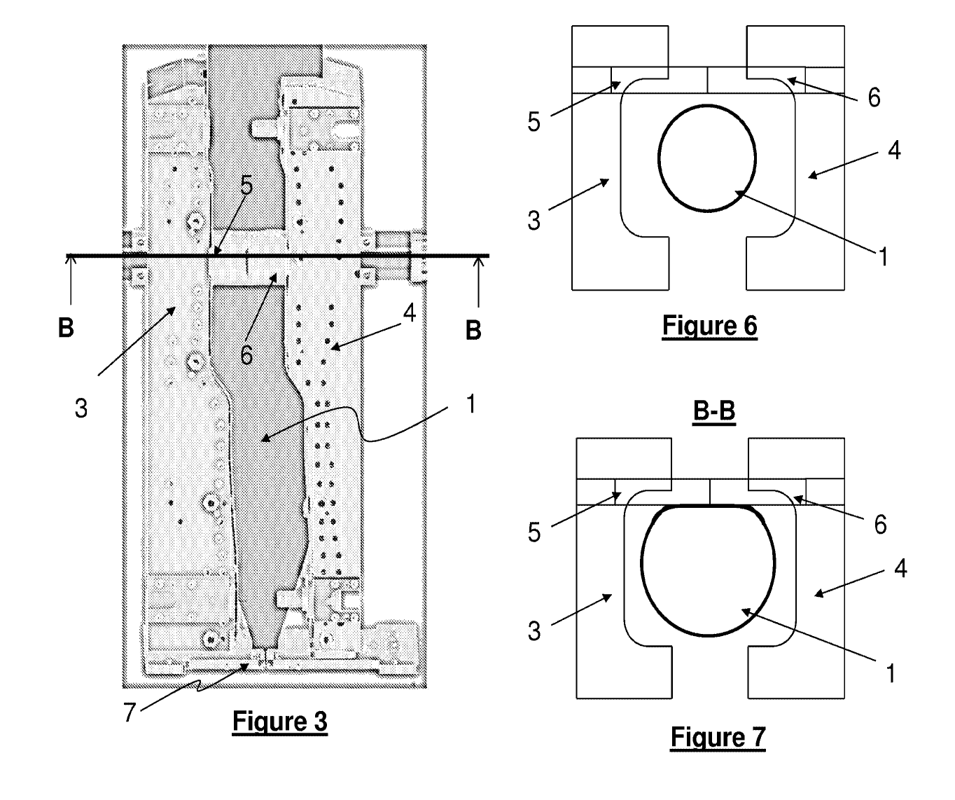

FIG. 3 shows the step of pre-blowing of the parison. In this step, a pressurized fluid is introduced into the interior of the parison (1) to inflate it, without it coming into contact with the internal surfaces (3′, 4′) of the mold cavities (3, 4) of the mold. A portion of the parison is therefore pressed onto the longitudinal member formed by the pair of mobile portions (5, 6). FIG. 7 is a view in section taken along the line B-B in FIG. 3.

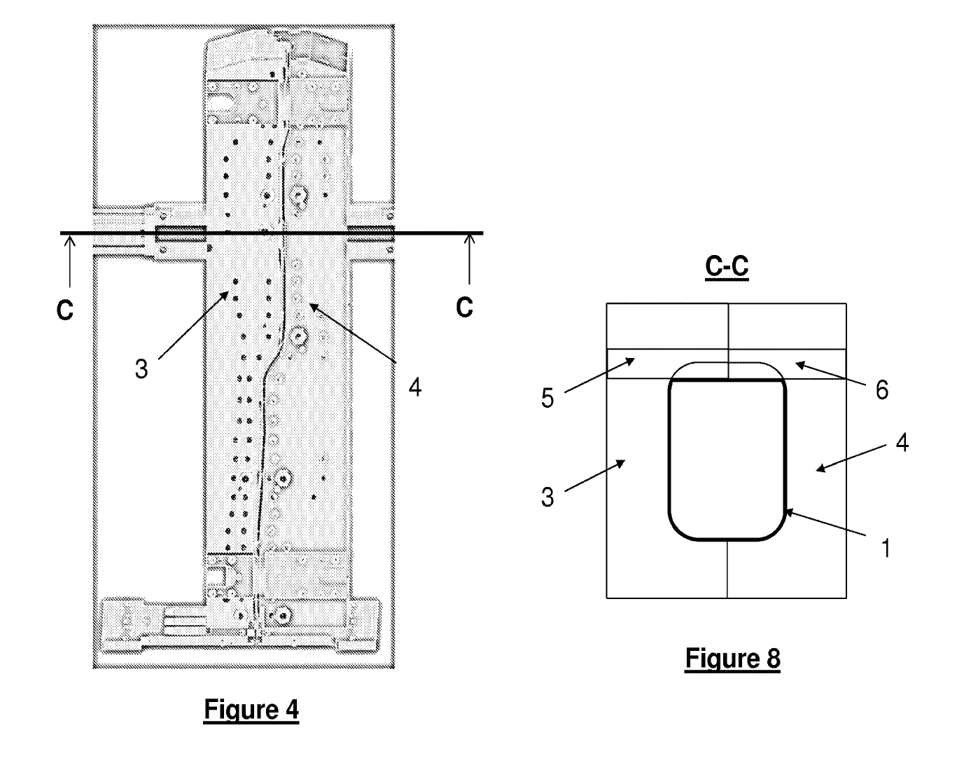

FIG. 4 shows the step of final blowing of the parison. During this step the mold is completely closed. It can be seen that the mold cavities of the mold are in contact at their perimeter. During this final blowing step, the longitudinal member occupies the same position as during the pre-blowing step. Said parison portion is therefore held out of the joint plane of the mold (i.e. the junction plane between the mold cavities of the mold) during the final blowing step, as shown in FIG. 8 (section taken along the line C-C in FIG. 4). Holding this parison portion out of the joint plane of the mold prevents it from being clamped between the mold cavities and therefore forming a weld. When everything is cooled, the tank may be removed from the mold. The tank produced in this way advantageously comprises an indentation with no projecting weld.

1-10. (canceled)

11. A method for producing a fuel tank from plastic material, comprising, in this order:
a) inserting a plastic parison into an open mold comprising mold cavities;
b) moving the mold cavities closer to close the mold;
c) before complete closure of the mold, introducing a pressurized fluid into an interior of the parison to perform pre-blowing of the parison;
d) once the mold cavities are in contact, carrying out a final blowing of the parison to press the parison onto the mold cavities of the mold with aid of the pressurized fluid;
e) opening the mold and extracting the tank;
wherein:
before the pre-blowing of the parison, introducing at least one obstacle element between the mold cavities; and
during the pre-blowing of the parison, pressing a portion of the parison onto the obstacle element with aid of the pressurized fluid, to prevent the portion of the parison from being clamped between the mold cavities of the mold to obtain a weld-free exterior perimeter area.

12. The method as claimed in claim 11, wherein the mold cavities of the mold each comprise at least one mobile portion and the mobile portions are configured to move closer to one another during the closure of the mold and to be assembled before the pre-blowing of the parison.

13. The method as claimed in claim 11, wherein at least one of the mold cavities of the mold comprises at least one mobile obstacle element.

14. The method as claimed in claim 11, further comprising mounting an accessory in the weld-free exterior perimeter area.

15. The method as claimed in claim 11, wherein the obstacle element is a longitudinal member.

16. The method as claimed in claim 11, wherein the obstacle element comprises raised patterns on its exterior surface.

17. The method as claimed in claim 11, wherein the obstacle element comprises thermal regulation means.

18. The method as claimed in claim 11, wherein the obstacle element comprises suction and/or blowing orifices.

19. The method as claimed in claim 11, wherein the obstacle element is made of metal.

20. A plastic material fuel tank manufactured by the method as claimed in claim 11.
